(19) United States
(12) Patent Application Publication
(10) Pub. No.: US 2009/0094146 A1
(43) Pub. Date: Apr. 9, 2009

(54) Methods, Systems, and Computer-Readable Media for Predicting an Effectiveness of a Cost Saving Opportunity

(76) Inventors: Robert Calvert, Alpharetta, GA (US); Terry Masty, Atlanta, GA (US); Charles Bowser, Hoschton, GA (US)

Correspondence Address: HOPE BALDAUFF HARTMAN, LLC, 1720 PEACHTREE STREET, N.W, SUITE 1010, ATLANTA, GA, 30309, US

(21) Appl. No.: 11/867,757

(22) Filed: Oct. 5, 2007

(51) Int. Cl. G06Q 40/00

(52) U.S. Cl. 705/35

(57) ABSTRACT

Methods, systems, and computer-readable media provide for predicting an effectiveness of a cost saving opportunity. According to embodiments of the method, a feasibility score, a financial impact score, and a risk score are determined. An effectiveness score is determined based on the feasibility score, the financial impact score, and the risk score. The feasibility score may indicate an anticipated ease with which to implement each cost saving opportunity. The financial impact score may indicate an anticipated cost savings resulting from implementing each cost saving opportunity. The risk score may indicate an anticipated level of business risk incurred by implementing each of the plurality of cost saving opportunities. The effectiveness score, which may be represented in one or two dimensions, indicates the anticipated effectiveness of each cost saving opportunity based on the feasibility score, the financial impact score, and the risk score.

### TECHNICAL FIELD

This application relates generally to the field of information technology. More specifically, the disclosure provided herein relates to the field of cost transformational savings in information technology.

### BACKGROUND

As computing devices have become more pervasive in business, companies and other organizations have developed dedicated information technology (“IT”) departments to administer the computing infrastructure within the organization. Among other things, IT departments provide user support, manage computing devices, manage the software executed on the computing device, and manage the networks on which the computing devices operate. As can be expected, supporting such diverse operations can be a significant cost for most organizations.

Generally speaking, IT departments are not considered profit centers for an organization. That is, IT departments typically do not directly produce any goods or provide any services that are sold for profit. However, the computing infrastructure supported by IT departments is often essential to the goods and/or services that generate income for the organization. Especially in the modern Internet age, even a relatively short downtime in availability of a computer network, for example, can lead to a significant amount of lost revenue. Nevertheless, the benefit provided by IT departments to the organization may be difficult to quantify, which leads to the preference of many organizations to limit the costs associated with operating their IT departments.

Cost spending and saving decisions are often made by high level executives or other decision-makers who are not fully knowledgeable about IT-related technology. Such decisions are often made based on a “gut feeling” without the benefit of objective support, which can lead to inconsistent and suboptimal results.

### SUMMARY

Embodiments of the disclosure presented herein include methods, systems, and computer-readable media for predicting an effectiveness of a cost saving opportunity. According to one aspect, a method for predicting an effectiveness of a plurality of cost saving opportunities is provided. According to the method, a feasibility score, a financial impact score, and a risk score are determined. Further, an effectiveness score is determined based on the feasibility score, the financial impact score, and the risk score. The feasibility score may indicate an anticipated effort with which to implement each of the plurality of cost saving opportunities. The feasibility score may be determined based on a plurality of feasibility values, each of which indicates a relevance of a given feasibility factor. The financial impact score may indicate an anticipated cost savings resulting from implementing each of the plurality of cost saving opportunities. The financial impact score may be determined based on a plurality of financial impact values, each of which indicates a relevance of a given financial impact factor. The risk score may indicate an anticipated level of business risk incurred by implementing each of the plurality of cost saving opportunities. The risk score may be determined based on a plurality of risk values, each of which indicates a relevance of a given risk factor. The effectiveness score indicates the anticipated effectiveness of each of the plurality of cost saving opportunities based on the feasibility score, the financial impact score, and the risk score.

According to another aspect, a system for predicting an effectiveness of a plurality of cost saving opportunities is provided. The system includes a memory and a processor functionally coupled to the memory. The memory stores a program containing code for predicting an effectiveness of a plurality of cost saving opportunities. The processor is responsive to computer-executable instructions contained in the program and operative to determine a feasibility score indicating an anticipated effort with which to implement each of the plurality of cost saving opportunities, determine a financial impact score indicating an anticipated cost savings resulting from implementing each of the plurality of cost saving opportunities, determine a risk score indicating an anticipated level of business risk incurred by implementing each of the plurality of cost saving opportunities, and determine an effectiveness score indicating the anticipated effectiveness of each of the plurality of cost saving opportunities based on the feasibility score, the financial impact score, and the risk score. The feasibility score is determined based on a plurality of feasibility values. Each of the plurality of feasibility values indicates a relevance of a given feasibility factor. The financial impact score is determined based on a plurality of financial impact values. Each of the plurality of financial impact values indicates a relevance of a given financial impact factor. The risk score is determined based on a plurality of risk values. Each of the plurality of risk values indicates a relevance of a given risk factor.

According to yet another aspect, a computer-readable medium having instructions stored thereon for execution by a processor to perform a method for predicting an effectiveness of a plurality of cost saving opportunities is provided. According to the method, a feasibility score, a financial impact score, and a risk score are determined. Further, an effectiveness score is determined based on the feasibility score, the financial impact score, and the risk score. The feasibility score may indicate an anticipated effort with which to implement each of the plurality of cost saving opportunities. The feasibility score may be determined based on a plurality of feasibility values, each of which indicates a relevance of a given feasibility factor. The financial impact score may indicate an anticipated cost savings resulting from implementing each of the plurality of cost saving opportunities. The financial impact score may be determined based on a plurality of financial impact values, each of which indicates a relevance of a given financial impact factor. The risk score may indicate an anticipated level of business risk incurred by implementing each of the plurality of cost saving opportunities. The risk score may be determined based on a plurality of risk values, each of which indicates a relevance of a given risk factor. The effectiveness score indicates the anticipated effectiveness of each of the plurality of cost saving opportunities based on the feasibility score, the financial impact score, and the risk score.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a block diagram illustrating a system configured to execute at least a portion of an infrastructure cost methodology, in accordance with exemplary embodiments.

FIG. 2 is a high-level diagram illustrating the infrastructure cost methodology, in accordance with exemplary embodiments.

FIG. 3 is a high-level diagram illustrating an exemplary implementation of the infrastructure cost methodology.

FIGS. 4A, 4B, and 4C illustrate an exemplary feasibility analysis diagram, an exemplary financial impact analysis diagram, and an exemplary risk analysis diagram, respectively.

FIG. 5 illustrate an exemplary opportunity map, which may be included in a business plan created during the infrastructure cost methodology.

### DETAILED DESCRIPTION

The following detailed description is directed to methods, systems, and computer-readable media for predicting an effectiveness of a cost saving opportunity. In the following detailed description, references are made to the accompanying drawings that form a part hereof, and which are shown by way of illustration through specific embodiments or examples.

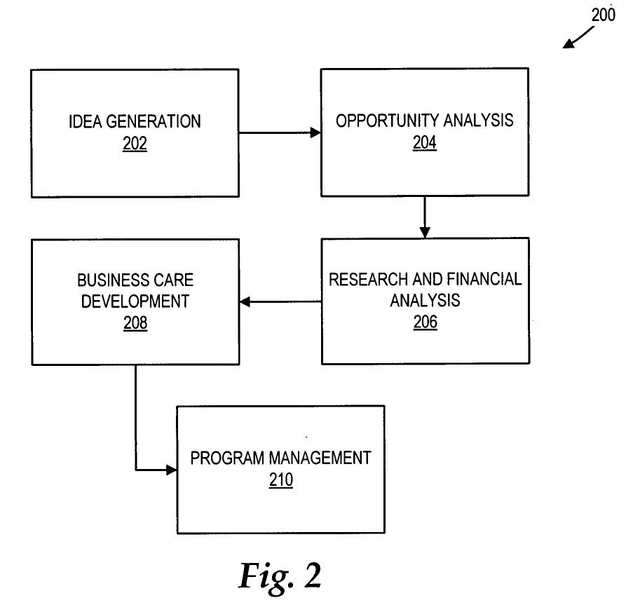

Embodiments described herein provide an infrastructure cost methodology, such as an infrastructure cost methodology 200 of FIG. 2, that finds cost saving opportunities for a computing infrastructure, qualifies the cost saving opportunities (i.e., will it save money?), quantifies the cost saving opportunities (i.e., how much money will it save?), implements the cost saving opportunities in the real-world, and validates the real-world benefit resulting from implementing the cost saving opportunities. Generally, cost saving opportunities can differ significantly. For example, one cost saving opportunity may involve changing office supply vendors, while another cost saving opportunity may involve implementing new servers. To aid in the evaluation of seemingly distinct cost saving opportunities, an effectiveness score is assigned to each cost saving opportunity, according to exemplary embodiments. The effectiveness score provides a decision-maker, such as a high level executive, a decision support tool with which to objectively compare different cost saving opportunities.

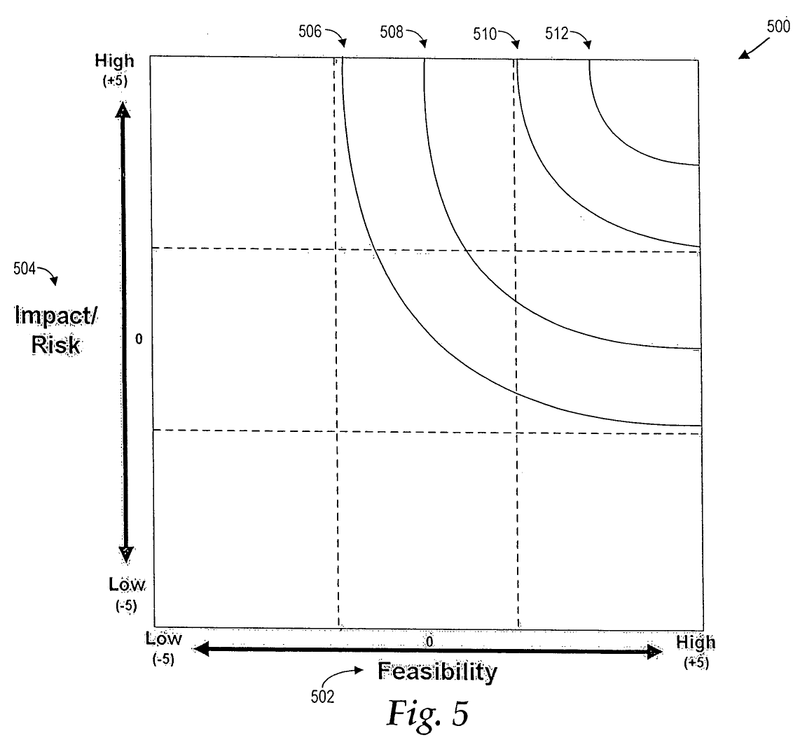

In one embodiment, the infrastructure cost methodology 200 includes an opportunity analysis phase 204 that determines a feasibility score, a financial impact score, and a risk score associated with each cost saving opportunity. The effectiveness score, which indicates the anticipated effectiveness of the given cost saving opportunity, may be determined based on the feasibility score, the financial impact score, and the risk score. The feasibility score, the financial impact score, and the risk score may be presented to the decision-maker for deciding whether to implement the given cost saving opportunity. In one embodiment, the feasibility score, the financial impact score, and the risk score are displayed in a graph, such as an opportunity map 500 of FIG. 5, or other visual diagram for easy viewing and interpretation. In this way, the decision-maker can make a more informed decision, based on objective evidence, regarding whether to fund and implement the given cost saving opportunity.

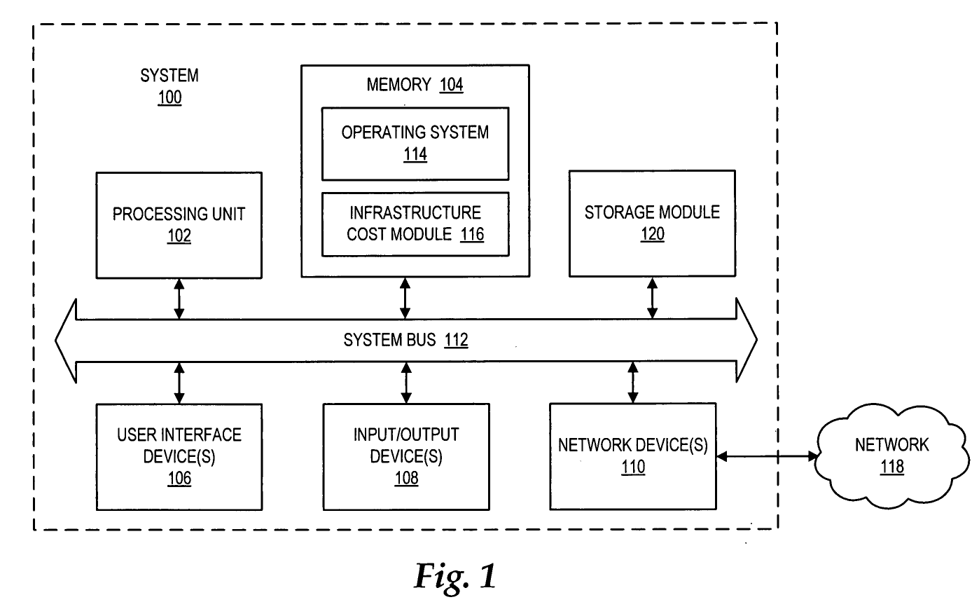

Referring now to the drawings, it is to be understood that like numerals represent like elements through the several figures, and that not all components and/or steps described and illustrated with reference to the figures are required for all embodiments. FIG. 1 and the following discussion are intended to provide a brief, general description of a suitable computing environment in which embodiments may be implemented. While embodiments will be described in the general context of program modules that execute in conjunction with an application program that runs on an operating system on a computer system, those skilled in the art will recognize that the embodiments may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. The embodiments may also be practiced in distributed computing environments where tasks are performed by remote processing devices that are linked through a communications network. In a distributed computing environment, program modules may be located in both local and remote memory storage devices.

FIG. 1 is a block diagram illustrating a system 100 configured to execute at least a portion of the infrastructure cost methodology 200 of FIG. 2, in accordance with exemplary embodiments. The system 100 includes a processing unit 102, a memory 104, one or more user interface devices 106, one or more input/output (“I/O”) devices 108, and one or more network devices 110, each of which is operatively connected to a system bus 112. The bus 112 enables bi-directional communication between the processing unit 102, the memory 104, the user interface devices 106, the I/O devices 108, and the network devices 110. Examples of the system 100 include, but are not limited to, computers, servers, personal digital assistants, cellular phones, or any suitable computing devices. The system may further include a storage module 120, commonly referred to as “disk space.” The storage module 120 may be directly attached to the system 100 or made available through a shared network connection, such as a network 118.

The processing unit 102 may be a standard central processor that performs arithmetic and logical operations, a more specific purpose programmable logic controller (“PLC”), a programmable gate array, or other type of processor known to those skilled in the art and suitable for controlling the operation of the server computer. Processing units are well-known in the art, and therefore not described in further detail herein.

The memory 104 communicates with the processing unit 102 via the system bus 112. In one embodiment, the memory 104 is operatively connected to a memory controller (not shown) that enables communication with the processing unit 102 via the system bus 112. The memory 104 includes an operating system 114 and an infrastructure cost module 116, according to exemplary embodiments. Examples of operating systems, such as the operating system 114, include, but are not limited to, WINDOWS operating system from MICROSOFT CORPORATION, LINUX operating system, and FREEBSD operating system. In one embodiment, the infrastructure cost module 116 is embodied in computer-readable media containing instructions that, when executed by the processing unit 102, performs a method for determining an effectiveness score, as described in greater detail below. According to further embodiments, the infrastructure cost module 116 may be embodied in hardware, software, firmware, or any combination thereof.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the system 100.

The user interface devices 106 may include one or more devices with which a user accesses the system 100. The user interface devices 106 may include, but are not limited to, computers, servers, personal digital assistants, cellular phones, or any suitable computing devices. The I/O devices 108 enable a user to interface with the infrastructure cost module 116. In one embodiment, the I/O devices 108 are operatively connected to an I/O controller (not shown) that enables communication with the processing unit 102 via the system bus 112. The I/O devices 108 may include one or more input devices, such as, but not limited to, a keyboard, a mouse, or an electronic stylus. Further, the I/O devices 108 may include one or more output devices, such as, but not limited to, a display screen or a printer.

The network devices 110 enable the system 100 to communicate with other networks or remote systems via a network 118. Examples of network devices 110 may include, but are not limited to, a modem, a radio frequency (“RF”) or infrared (“IR”) transceiver, a telephonic interface, a bridge, a router, or a network card. The network 118 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such a WiMAX network, or a cellular network. Alternatively, the network 118 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

The storage module 120 may include one or more disk drives containing a suitable amount of longer term file storage. The storage module 120 may be directly attached to the system 100 via the system bus 112, as illustrated in the example shown in FIG. 1. In further embodiments, the storage module 120 may be at least an allocated portion of an external storage device accessible via the network 118. The storage module 120 may store program executables, library code (e.g., dynamic-link library (“DLL”)), and other suitable data for enabling proper execution of the system 100. The storage module 120 may further store one or more databases, for which functionality may be provided via commercial off-the-shelf (“COTS”) and/or custom-developed software, hardware, firmware, and the like. Examples of databases may include, but are not limited to ORACLE from ORACLE CORPORATION and SQL SERVER from MICROSOFT CORPORATION. The storage module 120 of the system 100 may be routinely backed up so that data stored in the storage module 120 may be restored for disaster recovery, business continuity, or other suitable purposes.

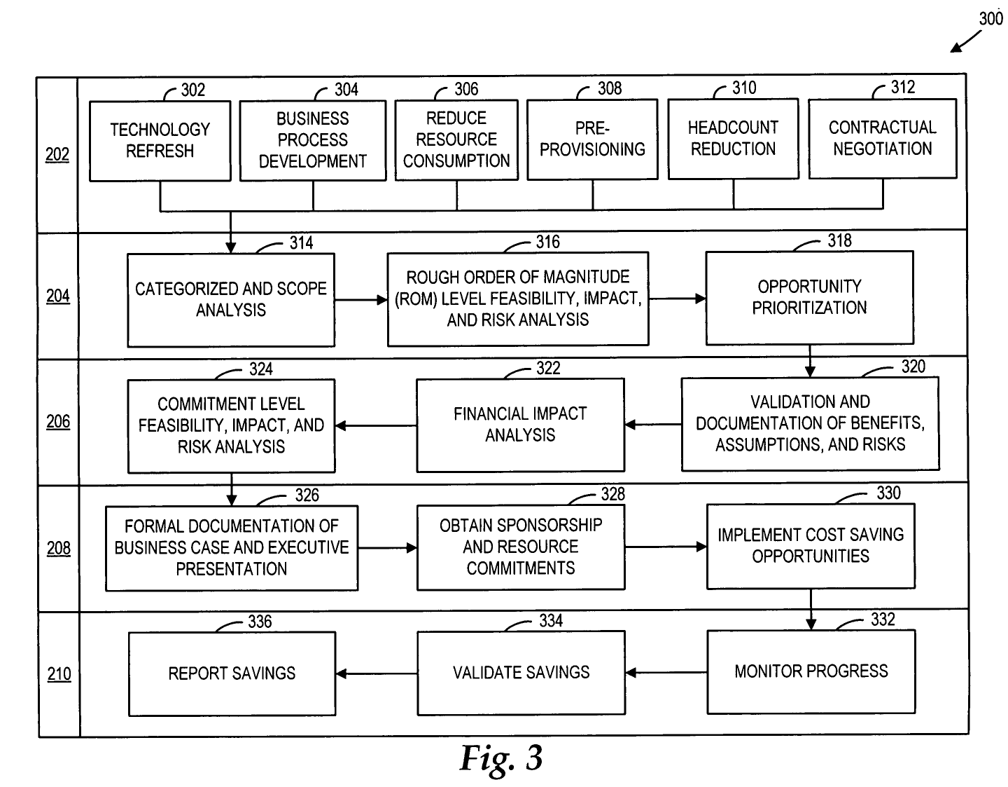

FIG. 2 is a high-level diagram illustrating the infrastructure cost methodology 200, in accordance with exemplary embodiments. According to exemplary embodiments, the infrastructure cost methodology 200 begins with an idea generation phase 202. In the idea generation phase 202, cost saving opportunities are identified. In one example, cost saving opportunities may be manually identified during a brainstorming meeting. In another example, cost savings opportunities may be automatically identified using a database containing previously identified cost saving opportunities. After a number of cost saving opportunities have been identified in the idea generation phase 202, the infrastructure cost methodology 200 proceeds to the opportunity analysis phase 204. Examples and categories of cost saving opportunities are described in greater detail below with respect to FIG. 3.

In the opportunity analysis phase 204, a feasibility score, a financial impact score, and a risk score may be determined for each of the identified cost saving opportunities. As used herein, the feasibility score refers to an objective determination regarding the business and technological feasibility of implementing a given cost saving opportunity. For example, a less feasible cost saving opportunity may require additional effort to implement, while a more feasible cost saving opportunity may require less effort to implement. A number of feasibility factors may affect the feasibility score including, but not limited to, whether current technology is capable of implementing the given cost saving opportunity, whether changes in standard business practices are necessary to implement the given cost saving opportunity, whether changes in organizational structures are necessary to implement the given cost saving opportunity, the maturity of the technology utilized to implement the given cost saving opportunity, and the length of time necessary to implement the given cost saving opportunity. In one embodiment, a high feasibility score indicates that the given cost saving opportunity is likely capable of being implemented using current business practices and technology, and a low feasibility score indicates that the given cost saving opportunity is not likely capable of being implemented using current business practices and technology.

As used herein, the financial impact score refers to an objective determination regarding the financial impact involved with implementing the given cost saving opportunity. The financial impact generally refers to the difference between cost savings anticipated by implementing the given cost saving opportunity and the costs associated with implementing the given cost saving opportunity. In this way, an expensive cost saving opportunity that is anticipated to save a significant amount of money may be given a lower financial impact score than an inexpensive cost saving opportunity that is anticipated to result in little or no cost savings. A number of financial impact factors may affect the financial score including, but not limited to, an investment amount to implement the given cost saving opportunity, a number of employees to support the given cost saving opportunity, an anticipated gross savings, the type of savings expected, whether the cost saving opportunity is directly aligned with strategic goals, and whether high-level executives or other decision-makers support the given cost saving opportunity. In one embodiment, a high financial impact score indicates that the given cost saving opportunity is relatively costly to implement, while a low financial impact score indicates that the given cost saving opportunity is relatively inexpensive to implement.

As used herein, the risk score refers to an objective determination regarding the business risks involved with implementing the given cost saving opportunity. A number of risk factors may affect the risk score including, but not limited to, whether implementing the given cost saving opportunity removes or creates a security exposure, whether implementing the given cost saving opportunity removes or adds a regulatory and/or legal burden, whether implementing the given cost saving opportunity removes or creates performance and/or capacity issues, and the age of the technology utilized to implement the given cost saving opportunity. In one embodiment, a high risk score indicates that the given cost saving opportunity is relatively high risk to implement, while a low risk score indicates that the given cost saving opportunity is relatively low risk to implement.

The feasibility score, the financial impact score, and the risk score may also be weighted to account for any preferences regarding the importance of each score. For example, some decision-makers may place a greater importance on the financial impact score, while other decision-makers may place a greater importance on the risk score. In one embodiment, the identified cost saving opportunities are displayed on the opportunity map 500, as described in greater detail below with respect to FIG. 5, in accordance with the feasibility score, the financial impact score, and the risk score.

In one embodiment, the identified cost saving opportunities are ranked or otherwise presented in accordance with the feasibility score, the financial impact score, the risk score, and other factors. After the opportunity analysis phase 204 is completed, the infrastructure cost methodology 200 proceeds to a research and financial analysis phase 206. In the research and financial analysis phase 206, a deep dive analysis of the feasibility score, the financial impact score, and the risk score determined in the opportunity analysis is performed. Due to the thorough and time-consuming nature of the deep dive analysis, an organization may prefer to analyze only highly ranked cost saving opportunities in this manner. While the feasibility score, the financial impact score, and the risk score may provide an initial impression as to the suitability of a given cost saving opportunity, the deep dive analysis may confirm whether the feasibility score, the financial impact score, and the risk score are correct. In particular, a number of assumptions may be made when addressing the feasibility factors, the financial impact factors, and the risk factors previously described. The deep dive analysis may involve validating those assumptions, as well as fine tuning those assumptions into more precise estimates.

In the research and financial analysis phase 206, a financial impact analysis may also be performed. While the financial impact score may provide an initial impression regarding the financial costs and benefits associated with implementing a given cost saving opportunity, the financial impact analysis may further confirm whether the financial impact score is correct. In particular, the financial impact analysis may involve documenting, among other costs, one-time costs and recurring costs associated with implementing the cost saving opportunity. For the sake of comparison, the financial impact analysis may also document the costs associated with alternative cost saving opportunities. The financial impact analysis may include a number of suitable metrics including, but not limited to, return on investment (“ROI”), net present value (“NPV”), and discounted payback period (“DPP”). ROI generally refers to the ratio of cost savings resulting from implementing the given cost saving opportunity relative to the costs associated with implementing the given cost saving opportunity. NPV generally refers to the difference between the present value of the anticipated cost savings and the present value of the costs associated with implementing the given cost saving opportunity. DPP generally refers to an amount of time necessary to recover the costs associated with implementing the given cost saving opportunity based on the present value of the anticipated cost savings.

By analyzing these metrics, a number of additional cost saving benefits may be revealed, such as indirect savings resulting from implementing the cost saving opportunity. [Inventors: Can you provide an example of an indirect savings? You also mention in your disclosure that there may be “a mitigation of known costs of not implementing a solution”? Can you provide an example of this as well?] According to exemplary embodiments, the feasibility score, the financial impact score, and the risk score are adjusted in accordance with the deep dive analysis and the financial impact analysis. If the research and financial analysis phase 206 results in the confirmation of a promising cost saving opportunity, the infrastructure cost methodology 200 proceeds to a business case development phase 208. [Inventors: Are there any firm thresholds that can be used to determine whether the results are promising or not based on the results of the research and financial analysis phase 206?]

In the business case development phase 208, a business plan or other suitable documents may be created that present the findings of the idea generation phase 202, the opportunity analysis phase 204, and/or the research and financial analysis phase 206 to the high-level executive or other decision-maker capable of approving and funding the implementation of the promising cost saving opportunity. Among other things, the business plan may summarize the promising cost saving opportunity including, but not limited to, the financial costs, the savings potential, the assumptions, and the risks associated with implementing the promising cost saving opportunity. In one embodiment, the business plan includes the opportunity map 500 of FIG. 5. If the decision-maker approves and funds the promising cost saving opportunity, the promising cost saving opportunity may be implemented in the real world. The infrastructure cost methodology 200 proceeds to a program management phase 210.

In the program management phase 210, the organization may monitor any financial progress made resulting from implementing the promising cost saving opportunity. In particular the financial progress may either validate or disprove the anticipated financial savings. In one embodiment, the financial progress may be included in a financial report which is provided to the high-level executive or other decision-maker.

FIG. 3 is a high-level diagram illustrating an exemplary implementation 300 of the infrastructure cost methodology 200 of FIG. 2. As illustrated in FIG. 3, the implementation 300 includes the idea generation phase 202, the opportunity analysis phase 204, the research and financial analysis phase 206, the business case development phase 208, and the program management phase 210. At the idea generation phase 202, a number of cost saving opportunities are identified. The cost saving opportunities may be identified during a brainstorming meeting or by accessing a database containing previously identified cost saving opportunities. For example, the database may be stored in the storage module 120 of FIG. 1. FIG. 3 illustrates a number of exemplary buckets 302, 304, 306, 308, 310, 312 in which identified cost saving opportunities are grouped. The buckets 302, 304, 306, 308, 310, 312 include the technology bucket 302, the business process bucket 304, the resource consumption bucket 306, the pre-provisioning bucket 308, the headcount bucket 310, and the contract bucket 312. It should be appreciated that the buckets 302, 304, 306, 308, 310, 312 illustrated in FIG. 3 are only exemplary. Other suitable buckets and groupings may be utilized according to further embodiments.

Referring to FIG. 3, the technology bucket 302 includes those opportunities that involve newer and more efficient technology. The technology bucket 302 may further include those opportunities that enable the removal of older technology or enable cost avoidance in the purchase of new technology. [Inventors: Any examples of cost avoidance?] According to exemplary embodiments, the business process bucket 304 includes those opportunities that involve engineering or re-engineering an existing business process to reduce waste, eliminate rework, accelerate results, increase quality, or reduce the amount of resources required to execute the process.

The resource consumption bucket 306 may include those opportunities that reduce the amount of a resources being consumed in a business process. These resources are often a significant cost for an organization. Examples of resources include, but are not limited to, energy, commodities (e.g., paper, toner), utilities, cooling, and computer hardware (e.g., mainframes, direct access storage devices). The pre-provisioning bucket 308 may include those opportunities that involve purchasing in bulk to leverage discounted prices for items that do not depreciate. The pre-provisioning bucket 308 may further include those opportunities that involve purchasing depreciable assets and making them available for use prior to their actual need.

According to exemplary embodiments, the headcount bucket 310 includes those opportunities that involve reductions in the number of employees and contractors utilized to perform a task, as well as those opportunities that involve reductions in the amount of compensation and benefits paid to employees and contractors. The headcount bucket 310 may further include those opportunities that involve reducing costs related to outsourced operations. The contract bucket 312 may include those opportunities that involve reductions in the amounts paid for underpinning contracts utilized in executing business processes. Examples of such opportunities include, but are not limited to, enterprise license agreements, changes to sourced contracts based on changing service level agreements (“SLAs”), cost avoidance enabled by skilled negotiators, and vendor changes to capitalize on better pricing.

As illustrated in FIG. 3, the identified cost saving opportunities stored in the buckets 302, 304, 306, 308, 310, 312 are provided to a categorization and scope analysis block 314 in the opportunity analysis phase 204. As its name suggests, the categorization and scope analysis block 314 generally involves two operations: a categorization operation and a scope analysis operation. In the categorization operation, the identified cost saving opportunities are grouped into business categories. For example, the categorization operation may involve grouping the identified cost saving opportunities by technology (e.g., servers, storage units, performance tuning), by type of savings (e.g., research and development, manufacturing, marketing, sales), by line of business in a multi-business enterprise (e.g., long distance, broadband, and wireline in a telecom enterprise; printers, computers, telephone handsets in an electronics manufacturing enterprise), or by corporate objectives (e.g., increase profit, increase growth, increase market share). Other suitable business categories, as contemplated by those skilled in the art, may be used as well.

It should be noted that, according to exemplary embodiments, the categories used for the categorization operation differ from the buckets 302, 304, 306, 308,310, 312 in the idea generation phase 202. In particular, the buckets 302, 304, 306, 308, 310, 312 are used to separate the cost saving opportunities by type, while the categories used for the categorization operation are used to align the cost saving opportunities by business priorities. [Inventors: Are the idea buckets relevant to the categorization operation? If not, where do the idea buckets come in?]

In the scope analysis operation, the extent to which each of the cost saving opportunities may be utilized within an organization is determined. The scope analysis operation may determine whether the identified cost saving opportunities can be utilized by only one department, an entire division, or the entire organization. A given cost saving opportunity may be considered to have a limited or localized scope if the cost saving opportunity is applicable to only one department. For example, the given cost saving opportunity may reduce headcount by one person in a particular department. Alternatively, a given cost saving opportunity may be considered to have a broad scope if the cost saving opportunity is applicable to the entire organization. For example, the given cost saving opportunity may involve switching from localized, attached storage devices to storage silos shared within the organization. After the categorization operation and the scope analysis operation are performed, the implementation 300 proceeds to a first feasibility, impact, and risk (“FIR”) analysis block 316.

In the first FIR analysis block 316, a high level determination of the feasibility score, the financial impact score, and the risk analysis score is made. In one embodiment, the feasibility score is determined by analyzing a plurality of feasibility factors, assigning a raw value to each of the feasibility factors, and weighting each of the raw values based on their importance. The raw values for each of the feasibility factors may then be summed to determine the feasibility score. In one embodiment, the financial impact score is determined by analyzing a plurality of financial impact factors, assigning a raw value to each of the financial impact factors, and weighting each of the raw values based on their importance. The raw values for each of the financial impact factors may then be summed to determine the financial impact score. In one embodiment, the risk analysis score is determined by analyzing a plurality of risk factors, assigning a raw value to each of the risk factors, and weighting each of the raw values based on their importance. The raw values for each of the risk factors may then be summed to determine the risk score.

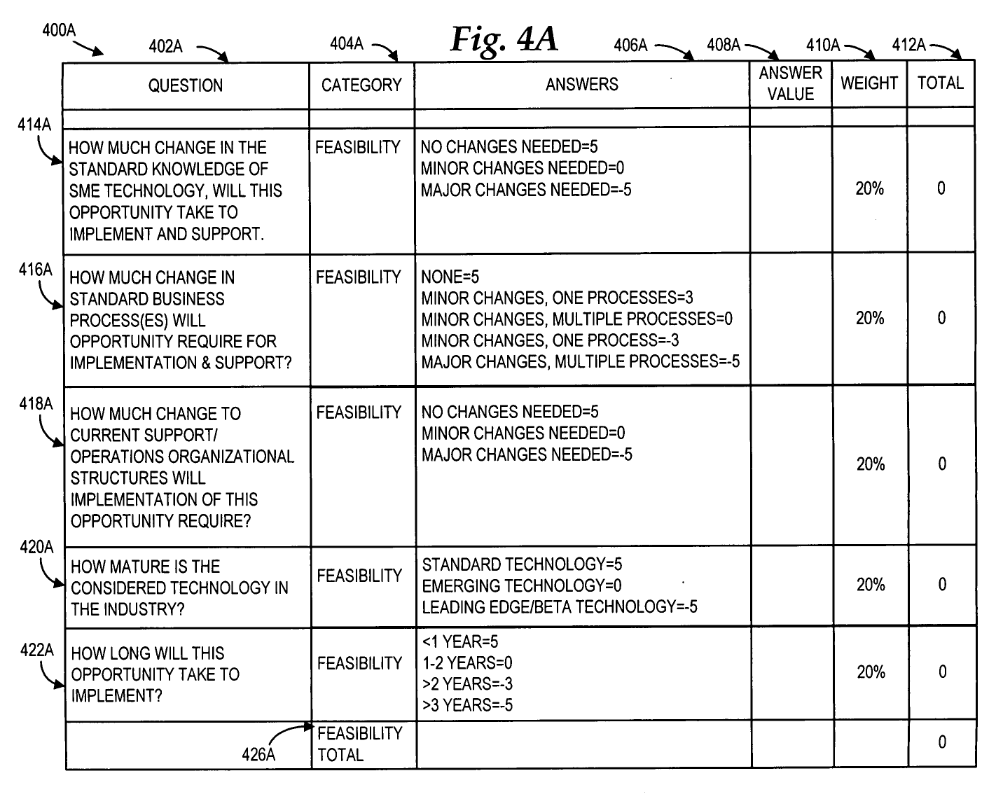

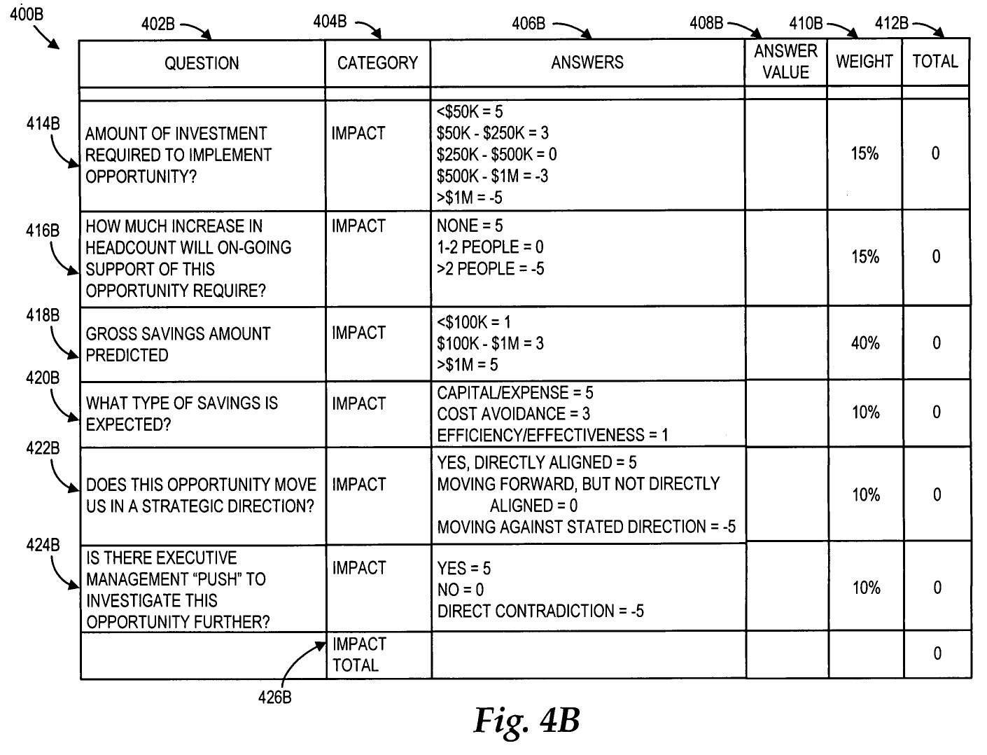

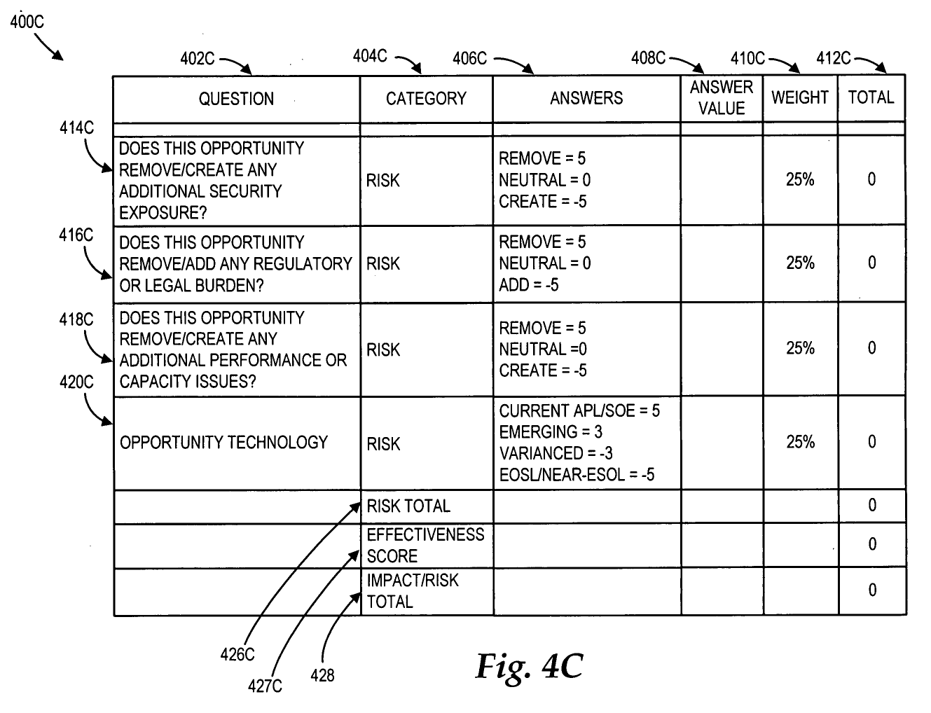

FIGS. 4A, 4B, and 4C illustrate an exemplary feasibility analysis diagram 400a, an exemplary financial impact analysis diagram 400b, and an exemplary risk analysis diagram 400c, respectively. It should be appreciated that the diagrams 400a, 400b, 400c may be included on a single document for easy viewing. Further, although not so limited, the diagrams 400a, 400b, 400c are illustrated in the form of a questionnaire, and the questions included therein are merely examples. It should be appreciated that other suitable questions may be substituted or added to the diagrams 400a, 400b, 400c, according to further embodiments.

Referring to FIG. 4A, the feasibility diagram 400a illustrates a questions column 402a, a category column 404a, an answers column 406a, an answer value column 408a, a weight column 410a, and a total column 412a. Under the columns 402a, 404a, 406a, 408a, 410a, 412a is a first row 414a, a second row 416a, a third row 418a, a fourth row 420a, and a fifth row 422a. The category column 404a indicates that the columns 402a, 404a, 406a, 408a, 410a, 412a are associated with a feasibility analysis. The questions column 402a provides a number of questions, each of which is related to one or more feasibility factors. For example, at the fourth row 420a, the questions column 402a asks whether the technology utilized in the proposed cost saving opportunity is mature. The answers column 406a associates a meaning to a numerical answer in the answer value column 408a. For example, at the fourth row 420a, the answers column 406a specifies that a negative five value indicates leading edge or beta technology, a zero value indicates an emerging technology, and a five value indicates a standard technology. The answer value column 408a is the numerical value associated with the questions in the questions column 402a. The weight column 410a associates a percentage of importance for each of the questions in the questions column 408a. As shown in FIG. 4A, the percentages under the weight column 410a add up to one-hundred percent. The total column 412a is the value in the answer value column 408a multiplied by the percentage in the weight column 410a. The feasibility diagram 400a further includes a feasibility total 426a. In one embodiment, the feasibility total 426a is the sum of the values under the total column 412a. A high feasibility total 426a may indicate that the proposed cost saving opportunity is highly feasible, while a low feasibility total 426a may indicate that the proposed cost saving opportunity is less feasible.

Referring to FIG. 4B, the financial impact diagram 400b illustrates a questions column 402b, a category column 404b, an answers column 406b, an answer value column 408b, a weight column 410b, and a total column 412b. Under the columns 402b, 404b, 406b, 408b, 410b, 412b is a first row 414b, a second row 416b, a third row 418b, a fourth row 420b, a fifth row 422b, and a sixth row 424b. The category column 404b indicates that the columns 402b, 404b, 406b, 408b, 410b, 412b are associated with a financial impact analysis. The questions column 402b provides a number of questions, each of which is related to one or more financial impact factors. For example, at the third row 418b, the questions column 402b asks how much savings is anticipated from implementing the proposed cost saving opportunity. The answers column 406b associates a meaning to a numerical answer in the answer value column 408b. For example, at the third row 418b, the answers column 406b specifies that a one value indicates cost savings of less than one hundred thousand dollars, a three value indicates cost savings between one hundred thousand dollars and one million dollars, and a five value indicates cost savings greater than one million dollars. The answer value column 408b is the numerical value associated with the questions in the questions column 402b. The weight column 410b associates a percentage of importance for each of the questions in the questions column 408b. As shown in FIG. 4B, the percentages under the weight column 410b add up to one-hundred percent. The total column 412b is the value in the answer value column 408b multiplied by the percentage in the weight column 410b. The financial impact diagram 400b further includes a financial impact total 426b. In one embodiment, the financial impact total 426b is the sum of the values under the total column 412b. A high financial impact total 426b may indicate that the proposed cost saving opportunity is anticipated to be highly effective, while a low financial impact total 426b may indicate that the proposed cost saving opportunity is anticipated to be less effective.

Referring to FIG. 4C, the risk diagram 400c illustrates a questions column 402c, a category column 404c, an answers column 406c, an answer value column 408c, a weight column 410c, and a total column 412c. Under the columns 402c, 404c, 406c, 408c, 410c, 412c is a first row 414c, a second row 416c, a third row 418c, and a fourth row 420c. The category column 404c indicates that the columns 402c, 404c, 406c, 408c, 410c, 412c are associated with a risk analysis. The questions column 402c provides a number of questions, each of which is related to one or more risk factors. For example, at the second row 416c, the questions column 402c asks whether implementing the cost saving opportunity removes or adds any regulatory or legal burden. The answers column 406c associates a meaning to a numerical answer in the answer value column 408c. For example, at the second row 416c, the answers column 406c specifies that a negative five value indicates that a regulatory or legal burden is added, a zero value indicates that any added or removed regulatory or legal burden is neither a benefit nor a consequence, and a five value indicates that a regulatory or legal burden is removed. The answer value column 408c is the numerical value associated with the questions in the questions column 402c. The weight column 410c associates a percentage of importance for each of the questions in the questions column 408c. As shown in FIG. 4C, the percentages under the weight column 410c add up to one-hundred percent. The total column 412c is the value in the answer value column 408c multiplied by the percentage in the weight column 410c. The risk diagram 400c further includes a risk total 426c. In one embodiment, the risk total 426c is determined by summing the values under the total column 412c. A high risk total 426c may indicate that implementing the proposed cost saving opportunity involves little risk, while a low risk total 426c may indicate that implementing the proposed cost saving opportunity involves much risk.

The risk diagram 400c also includes an effectiveness score 428, which is determined by summing the feasibility total 426a, the financial impact total 426b, and the risk total 426c, according to exemplary embodiments. A high effectiveness score 428 may indicate a high recommendation to implement the given cost saving opportunity, while a low effectiveness score 428 may indicate a low recommendation to implement the proposed cost saving opportunity. After determining the effectiveness score 428 for the identified cost saving opportunities, the implementation 300 proceeds to an opportunity prioritization block 318.

Referring again to FIG. 3, in the opportunity prioritization block 318, the identified cost saving opportunities are ranked by priority. In this way, the more promising cost saving opportunities may be distinguished from the less promising cost saving opportunities. In one embodiment, the ranking is determined based on the effectiveness scores, the results of the categorization operation, and/or the results of the scope analysis operation. In one example, cost saving opportunities belonging to certain categories utilized by the categorization operation may be deemed to be higher priority than cost saving opportunities belonging in other categories. In another example, cost saving opportunities associated with a certain scope (e.g., a broad scope) may be deemed to be higher priority than cost saving opportunities associated with other scopes (e.g., a local scope). After the identified cost saving opportunities are ranked by priority, the implementation 300 proceeds to a validation and documentation block 320.

In the validation and documentation block 320, a deep dive analysis is performed on any benefits, assumptions, and risks utilized to determine the effectiveness score 428. In particular, the benefits, assumptions, and risks utilized to determine the effectiveness score 428 may be verified and documented. Due to thorough and time-consuming nature of the deep dive analysis, the deep dive analysis may be performed on only the more promising cost saving opportunities according to the results of the opportunity prioritization block 318. [Inventors: Any additional information to provide concerning the deep dive analysis?] The implementation 300 then proceeds to a financial impact analysis block 322.

In the financial impact analysis block 322, one time and recurring costs associated with implementing the promising cost saving opportunity may be documented. For the sake of comparison, a number of suitable metrics may be generated including, but not limited to, return on investment (“ROI”), net present value (“NPV”), and discounted payback period (“DPP”). By analyzing these metrics, a number of additional cost saving benefits may be revealed, such as indirect savings resulting from implementing the promising cost saving opportunity. The implementation 300 then proceeds to a second FIR analysis block 324. In the second FIR analysis block 324, the effectiveness score 428 is further adjusted based on the results of the validation and documentation block 320 and the financial impact analysis block 324. The implementation 300 then proceeds to the business case development block 326.

In the business case development block 326, a business plan or other suitable documents may be created that present the findings of the idea generation phase 202, the opportunity analysis phase 204, and/or the research and financial analysis phase 206 to the high level executive or other decision-maker capable of approving and funding the implementation of the promising cost saving opportunity. Among other things, the business plan may summarize the cost saving opportunity including, but not limited to, the financial costs, the savings potential, the assumptions, and the risks associated with implementing the promising cost saving opportunity.

In one embodiment, the business plan includes the opportunity map 500 of FIG. 5. Referring to FIG. 5, the opportunity map 500 provides a graphical representation of the effectiveness score 428. As shown on the opportunity map 500, a X-axis 502 represents the feasibility total 426a. A Y-axis 504 represents the financial impact total 426b and the risk total 426c. For the sake of simplicity, the financial impact total 426b and the risk total 426c have been averaged into a single value to be shown on the Y-axis 504. In further embodiments, the financial impact total 426b and the risk total 426c may remain separate. A higher value along the X-axis 502 generally indicates higher feasibility, while a lower value along the X-axis 502 indicates lower feasibility. A higher value along the Y-axis 504 generally indicates higher cost savings and lower risk, while a lower value along the Y-axis 504 generally indicates lesser cost savings and higher risk. As such, cost saving opportunities that have high values on both the X-axis 502 and the Y-axis 504 are generally preferred.

The opportunity map 500 illustrates a first cost saving opportunity 506, a second cost saving opportunity 508, a third cost saving opportunity 510, and a fourth cost saving opportunity 512. The first cost saving opportunity 506 has lower values on both the X-axis 502 and the Y-axis 504 than the second cost saving opportunity 508. As such, the second cost saving opportunity 508 is preferred over the first cost saving opportunity 506. The second cost saving opportunity 508 has lower values on both the X-axis 502 and the Y-axis 504 than the third cost saving opportunity 510. As such, the third cost saving opportunity 510 is preferred over the second cost saving opportunity 508. The third cost saving opportunity 510 has lower values on both the X-axis 502 and the Y-axis 504 than the fourth cost saving opportunity 512. As such, the fourth cost saving opportunity 512 is preferred over the third cost saving opportunity 510.

It should be appreciated that the opportunity map 500 may be used to show the results of the first FIR analysis block 316 and/or the second FIR analysis block 324. The implementation 300 proceeds to a sponsorship block 328 in which the business plan is presented to a decision-maker, such as a high-level executive, and funding is obtained to implement the selected cost saving opportunity. After funding is obtained, the implementation 300 proceeds to an implementation block 330 in which selected cost saving opportunity is implemented in the real world. The implementation 300 continues to a monitoring block 332, a validation block 334, and a reporting block 336. In the monitoring block 332, any actual cost savings resulting from the selected cost saving opportunity is monitored and recorded. In the validation block 334, the actual cost savings is compared to anticipated cost savings determined during the financial impact analysis. The results of the comparison are reported to the decision-maker, such as the high-level executive, in the reporting block 336.

Although the subject matter presented herein has been described in conjunction with one or more particular embodiments and implementations, it is to be understood that the embodiments defined in the appended claims are not necessarily limited to the specific structure, configuration, or functionality described herein. Rather, the specific structure, configuration, and functionality are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the embodiments, which is set forth in the following claims.

What is claimed is:

1. A method for predicting an effectiveness of a plurality of cost saving opportunities, comprising:
determining a feasibility score indicating an anticipated effort with which to implement each of the plurality of cost saving opportunities, wherein the feasibility score is determined based on a plurality of a feasibility values, each of the plurality of feasibility values indicating a relevance of a given feasibility factor;
determining a financial impact score indicating an anticipated cost savings resulting from implementing each of the plurality of cost saving opportunities, wherein the financial impact score is determined based on a plurality of a financial impact values, each of the plurality of financial impact values indicating a relevance of a given financial impact factor;
determining a risk score indicating an anticipated level of business risk incurred by implementing each of the plurality of cost saving opportunities, wherein the risk score is determined based on a plurality of a risk values, each of the plurality of risk values indicating a relevance of a given risk factor; and
determining an effectiveness score indicating the anticipated effectiveness of each of the plurality of cost saving opportunities based on the feasibility score, the financial impact score, and the risk score.

2. The method of claim 1, further comprising:
identifying the plurality of cost saving opportunities;
grouping each of the plurality of cost saving opportunities into a business category; and
determining a scope of applicability of each of the plurality of cost saving opportunities.

3. The method of claim 2, further comprising prioritizing the plurality of cost saving opportunities based on the effectiveness score, the business category, and the scope of applicability to generate a prioritized list of cost saving opportunities.

4. The method of claim 3, further comprising validating assumptions utilized to determine the feasibility score, the financial impact score, and the risk score for a promising cost saving opportunity in the prioritized list of cost saving opportunities.

5. The method of claim 4, further comprising generating a plurality of metrics for the promising cost saving opportunity, the plurality of metrics comprising at least one of return on investment, net present value, and discounted payback period.

6. The method of claim 5, further comprising adjusting the effectiveness score based on at least one of the business category, the scope of applicability, whether the assumptions are validated, and the plurality of metrics.

7. The method of claim 1, further comprising generating an opportunity map graphically displaying the feasibility score, the financial impact score, and the risk score.

8. A system for predicting an effectiveness of a plurality of cost saving opportunities, comprising:
a memory for storing a program containing code for predicting the effectiveness of the plurality of cost saving opportunities;
a processor functionally coupled to the memory, the processor being responsive to computer-executable instructions contained in the program and operative to:
determine a feasibility score indicating an anticipated effort with which to implement each of the plurality of cost saving opportunities, wherein the feasibility score is determined based on a plurality of a feasibility values, each of the plurality of feasibility values indicating a relevance of a given feasibility factor,
determine a financial impact score indicating an anticipated cost savings resulting from implementing each of the plurality of cost saving opportunities, wherein the financial impact score is determined based on a plurality of a financial impact values, each of the plurality of financial impact values indicating a relevance of a given financial impact factor,
determine a risk score indicating an anticipated level of business risk incurred by implementing each of the plurality of cost saving opportunities, wherein the risk score is determined based on a plurality of a risk values, each of the plurality of risk values indicating a relevance of a given risk factor, and
determine an effectiveness score indicating the anticipated effectiveness of each of the plurality of cost saving opportunities based on the feasibility score, the financial impact score, and the risk score.

9. The system of claim 8, wherein the processor is further operative to:
identify the plurality of cost saving opportunities,
group each of the plurality of cost saving opportunities into a business category, and
determine a scope of applicability of each of the plurality of cost saving opportunities.

10. The system of claim 9, wherein the processor is further operative to prioritize the plurality of cost saving opportunities based on the effectiveness score, the business category, and the scope of applicability to generate a prioritized list of cost saving opportunities.

11. The system of claim 10, wherein the processor is further operative to validate assumptions utilized to determine the feasibility score, the financial impact score, and the risk score for a promising cost saving opportunity in the prioritized list of cost saving opportunities.

12. The system of claim 11, wherein the processor is further operative to generate a plurality of metrics for the promising cost saving opportunity, the plurality of metrics comprising at least one of return on investment, net present value, and discounted payback period.

13. The system of claim 12, wherein the processor is further operative to adjust the effectiveness score based on at least one of the business category, the scope of applicability, whether the assumptions are validated, and the plurality of metrics.

14. A computer-readable medium having instructions stored thereon for execution by a processor to perform a method for predicting an effectiveness of a plurality of cost saving opportunities, the method comprising:
determining a feasibility score indicating an anticipated effort with which to implement each of the plurality of cost saving opportunities, wherein the feasibility score is determined based on a plurality of a feasibility values, each of the plurality of feasibility values indicating a relevance of a given feasibility factor;
determining a financial impact score indicating an anticipated cost savings resulting from implementing each of the plurality of cost saving opportunities, wherein the financial impact score is determined based on a plurality of a financial impact values, each of the plurality of financial impact values indicating a relevance of a given financial impact factor;
determining a risk score indicating an anticipated level of business risk incurred by implementing each of the plurality of cost saving opportunities, wherein the risk score is determined based on a plurality of a risk values, each of the plurality of risk values indicating a relevance of a given risk factor; and
determining an effectiveness score indicating the anticipated effectiveness of each of the plurality of cost saving opportunities based on the feasibility score, the financial impact score, and the risk score.

15. The computer-readable medium of claim 14, the method further comprising:
identifying the plurality of cost saving opportunities;
grouping each of the plurality of cost saving opportunities into a business category; and
determining a scope of applicability of each of the plurality of cost saving opportunities.

16. The computer-readable medium of claim 15, the method further comprising prioritizing the plurality of cost saving opportunities based on the effectiveness score, the business category, and the scope of applicability to generate a prioritized list of cost saving opportunities.

17. The computer-readable medium of claim 16, the method further comprising validating assumptions utilized to determine the feasibility score, the financial impact score, and the risk score for a promising cost saving opportunity in the prioritized list of cost saving opportunities.

18. The computer-readable medium of claim 17, the method further comprising generating a plurality of metrics for the promising cost saving opportunity, the plurality of metrics comprising at least one of return on investment, net present value, and discounted payback period.

19. The computer-readable medium of claim 18, the method further comprising adjusting the effectiveness score based on at least one of the business category, the scope of applicability, whether the assumptions are validated, and the plurality of metrics.

20. The computer-readable medium of claim 14, the method further comprising generating an opportunity map graphically displaying the feasibility score, the financial impact score, and the risk score.
